(19) United States
(12) Patent Application Publication
(10) Pub. No.: US 2025/0284045 A1
(43) Pub. Date: Sep. 11, 2025

(54) VOLUME HOLOGRAPHIC OPTICAL ELEMENTS TO AVOID GHOST NOISE

(71) Applicant: National Central University, Taoyuan City (TW)

(72) Inventors: Wen-Kai Lin, Taoyuan City (TW); Shao-Kui Zhou, Taipei City (TW); Wei-Chia Su, Changhua City (TW); Ching-Cherng Sun, Taoyuan City (TW); Shiuan-Huei Lin, HsinChu City (TW); Yeh-Wei Yu, Taoyuan City (TW); Tsung-Hsun Yang, Taoyuan City (TW)

(21) Appl. No.: 18/635,822

(22) Filed: Apr. 15, 2024

(30) Foreign Application Priority Data
Mar. 8, 2024 (TW) 113108672

(51) Int. Cl. G02B 5/32; G02B 27/00

(52) U.S. Cl. CPC G02B 5/32; G02B 27/0018

(57) ABSTRACT

The present invention relates to volume holographic optical elements to avoid ghost noise. The volume holographic optical element comprises a plurality of volume gratings, which correspond to different incident angle lights, respectively, and have vectors designed with identical components horizontal to an incident interface and possess identical grating periods horizontal to the incident interface. When a device (e.g., head-mounted display) associated with volume holographic optical technology employs the volume holographic optical technology designed by the present invention, angle multiplexing by the volume holographic optical element enables overlapping of images coupled in and out of light guide through different gratings, thereby avoiding the occurrence of ghost noise.

### BACKGROUND OF THE INVENTION

### Fields of the Invention

The present invention relates to volume holographic optical elements to avoid ghost noise and applicable to volume holographic optical technology.

### Descriptions of Related Art

Volume holographic optical technology is mainly applied in head-mounted displays, such as glasses-type displays.

The core component in volume holographic optical technology is a volume holographic optical element (VHOE), which exhibits strict angular selectivity, resulting in a very narrow visible angle for observing images. To expand the visible angle for images, it is necessary to increase the number of volume gratings within the volume holographic optical element, thereby facilitating angle multiplexing and enabling the target rays to diffract at various angles.

However, after angle multiplexing, ghost noise may arise due to coupling of light by volume gratings of different periods when entering and exiting the light guide. For example, as shown in FIGS. 11 and 12, when light enters the volume grating G1 of the incident volume holographic optical element, ideally, the light processed by the volume grating G1 should diffract within the light guide and enter the volume grating H1 of the exit volume holographic optical element. However, in practice, various environmental disturbances may cause a small portion of the light processed by the volume grating G1 to enter the volume grating H2 after diffraction within the light guide. This can result in the image not appearing at the target position and instead manifesting as ghost noise.

### SUMMARY OF THE INVENTION

The objective of the present invention is to enable volume holographic optical elements to overlap images coupled in and out of light guide through different gratings after angle multiplexing, thereby avoiding the occurrence of ghost noise.

To achieve the above objectives and effects, the present invention provides a volume holographic optical element to avoid ghost noise. The volume holographic optical element comprises a plurality of volume gratings, which correspond to different incident angle lights, respectively, and have vectors designed with identical components horizontal to an incident interface and possess identical grating periods horizontal to the incident interface.

### BRIEF DESCRIPTION OF THE DRAWINGS

FIG. 1 is a schematic diagram for illustrating calculation of diffraction angles.

FIG. 2 is a schematic diagram for illustrating the relationship of K_{g,x} between two volume gratings of a traditional volume holographic optical element for light entering and exiting.

FIG. 3 is a schematic diagram for illustrating the angle and vector relationship between two volume gratings of a volume holographic optical element designed by the present invention for light entering and exiting.

FIG. 4 is a schematic diagram for illustrating the relationship of K_{g,x} between two volume gratings of a volume holographic optical element designed by the present invention for light entering and exiting.

FIG. 5 is a first schematic diagram for illustrating the absence of ghost noise when light enters and exits a volume holographic optical element designed by the present invention.

FIG. 6 is a second schematic diagram for illustrating the absence of ghost noise when light enters and exits a volume holographic optical element designed by the present invention.

FIG. 7 is a third schematic diagram for illustrating the absence of ghost noise when light enters and exits a volume holographic optical element designed by the present invention.

FIG. 8 is a fourth schematic diagram for illustrating the absence of ghost noise when light enters and exits a volume holographic optical element designed by the present invention.

FIG. 9 is a schematic diagram for illustrating experimental data of the present invention.

FIG. 10 is a schematic diagram for showing the absence of ghost noise in imaging when utilizing a device equipped with a volume holographic optical element designed by the present invention.

FIG. 11 is a first schematic diagram for illustrating prior art.

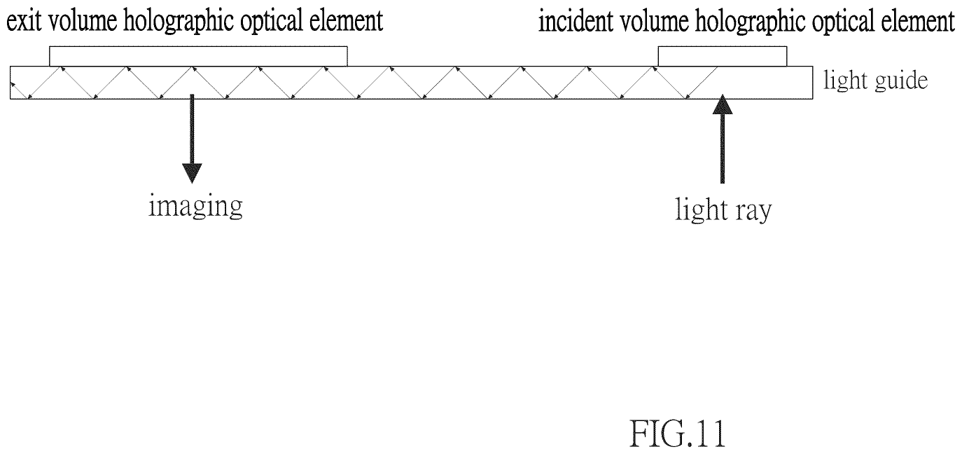

FIG. 12 is a second schematic diagram for illustrating prior art.

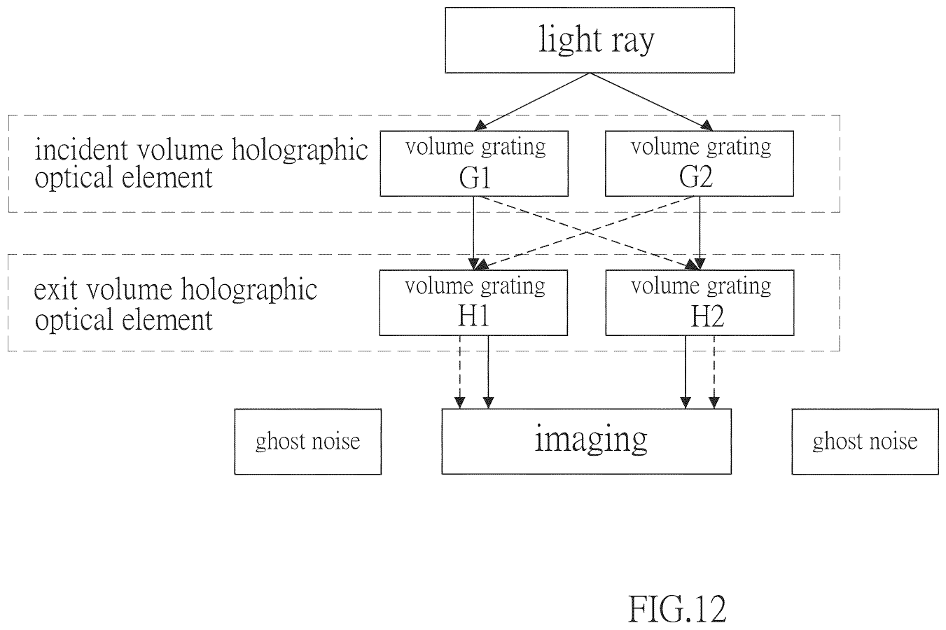

### DETAILED DESCRIPTION OF THE PREFERRED EMBODIMENT

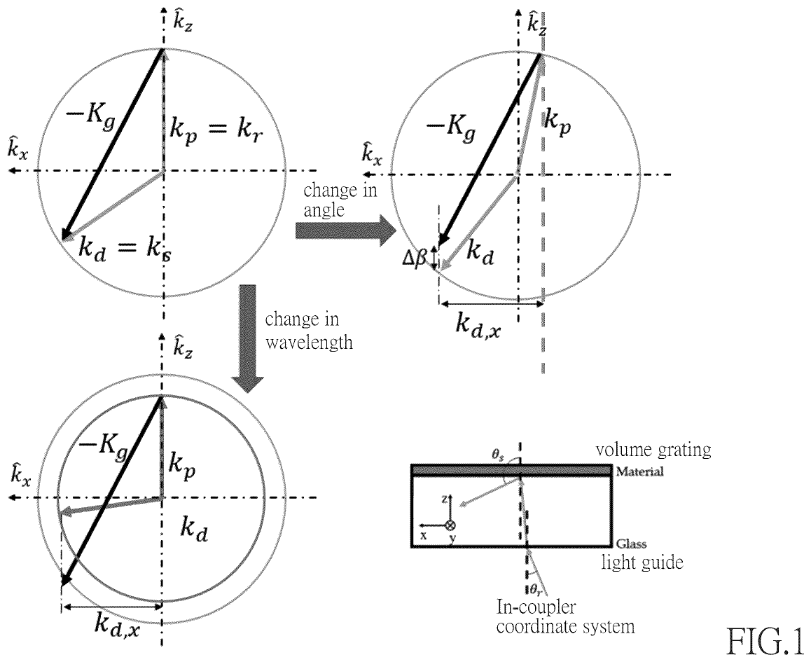

To facilitate the understanding of the “Volume Holographic Optical Elements to Avoid Ghost Noise” according to the present invention, the calculation method of the diffraction angle is introduced in conjunction with FIG. 1. When light enters the incident volume grating at different angles or wavelengths, if the probe light vector is kₚ and the diffracted light vector is k_{d}, considering momentum conservation, the components of k_{d,x} and k_{d,y} for k_{d} projected onto the interface can be expressed as follows:

$${k}_{d , x} = {k}_{p , x} - {K}_{g , x}$$

$${k}_{d , y} = {k}_{p , y} - {K}_{g , y} = {k}_{p , y}$$

Considering energy conservation, the z-component is:

$${k}_{d , z} = \sqrt{{( n \frac{2 π}{{λ}_{0}} )}^{2} - {k}_{d , x}^{2} - {k}_{d , y}^{2}}$$

The vector k of the diffracted light can be represented as:

$${k}_{d , x} = {k}_{p , x} - {K}_{g , x}$$

$${k}_{d , y} = {k}_{p , y} - {K}_{g , y}$$

$${k}_{d , z} = \sqrt{{( n \frac{2 π}{{λ}_{0}} )}^{2} - {k}_{d , x}^{2} - {k}_{d , y}^{2}}$$

In the diagram, x, y and z represent the x, y, z components of their physical quantities, λₚ is the wavelength of the probe light, and n is the refractive index. At this point, the diffraction angle of the diffracted light entering the two volume gratings can be expressed as:

$${θ}_{d} = {sin}^{- 1} ( \frac{{k}_{d , x}}{\vert n \frac{2 π}{{λ}_{p}} \vert} ) = {sin}^{- 1} ( \frac{{k}_{p , x} - {K}_{g , x}}{\vert n \frac{2 π}{{λ}_{p}} \vert} )$$

Continuing, to explain the specific distinctions between the traditional volume holographic optical element and the volume holographic optical element designed in the present invention, the number of volume gratings employed in the volume holographic optical element is exemplified by 2. The actual number can be adjusted according to requirements.

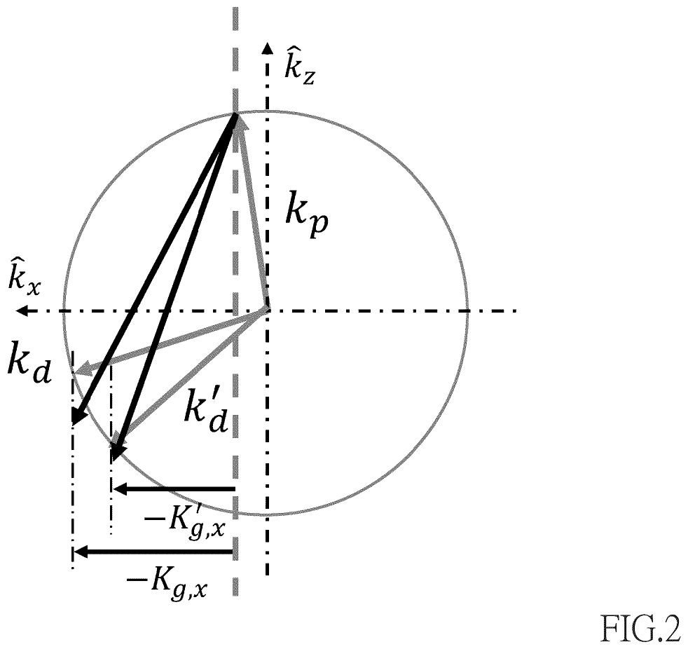

In the traditional volume holographic optical element, because only the corresponding incident light angle is changed, the angle relationship will be as shown in FIG. 2. Since K_{g,x} and K′_{g,x} are not identical, when light processed by each volume grating of the incident volume holographic optical element enters an incorrect volume grating of the exit volume holographic optical element, the disparity in diffraction angles leads to imaging at an unexpected position, resulting in ghost noise.

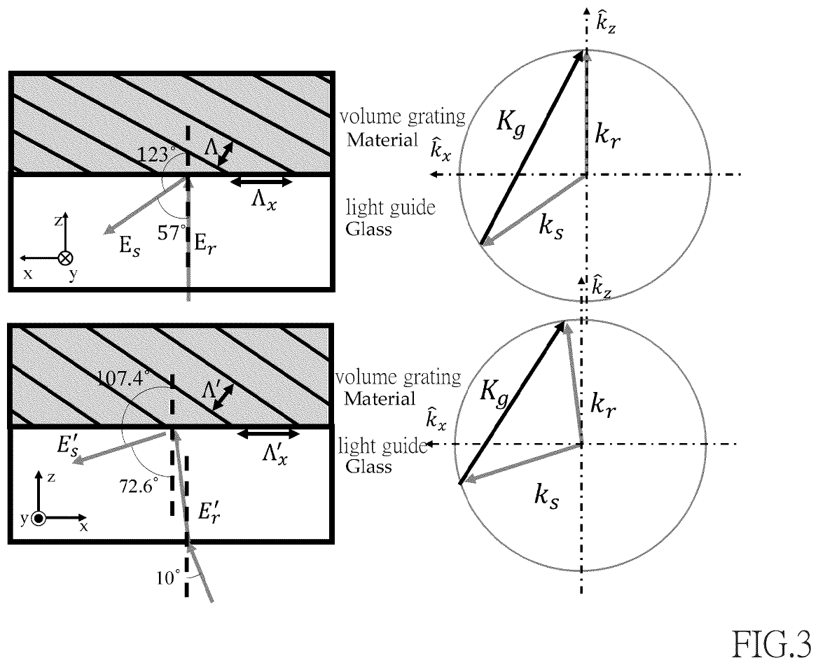

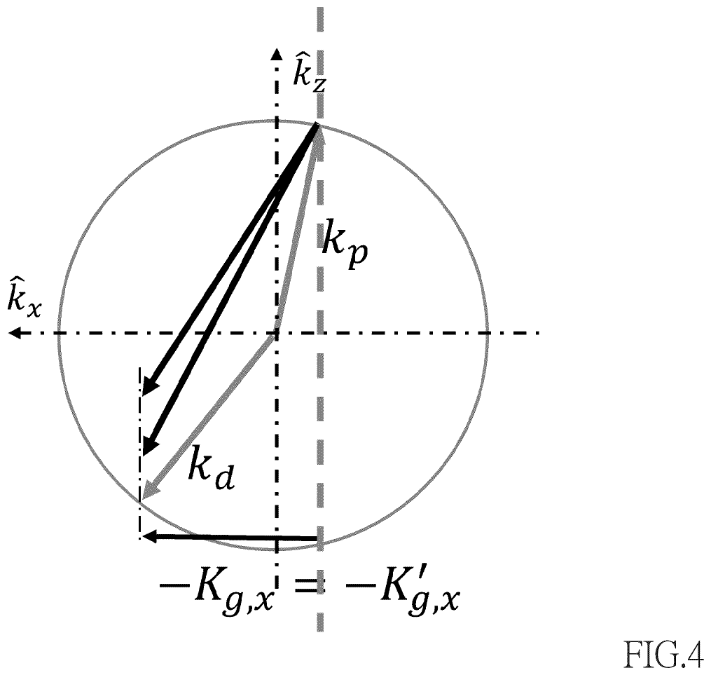

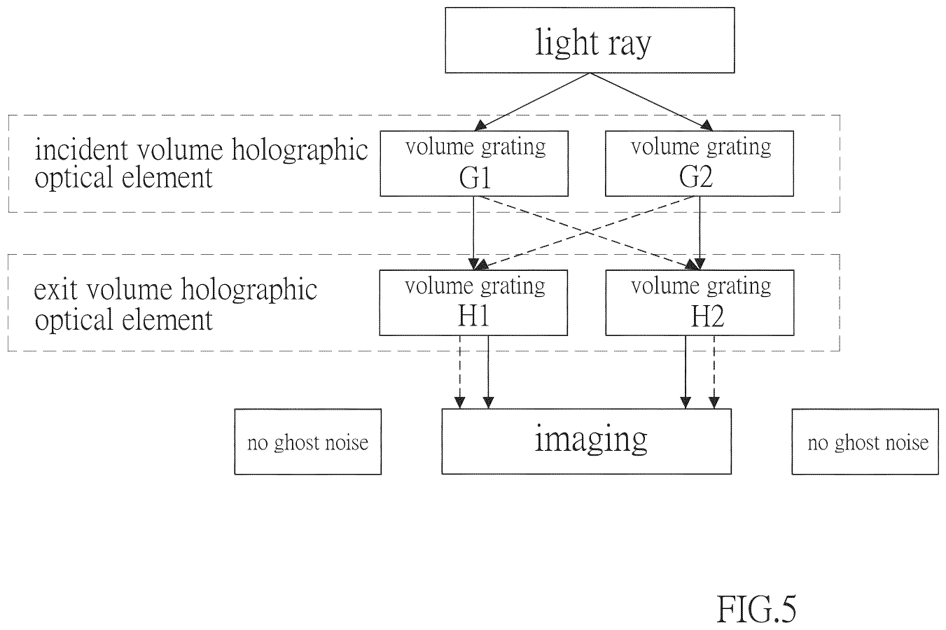

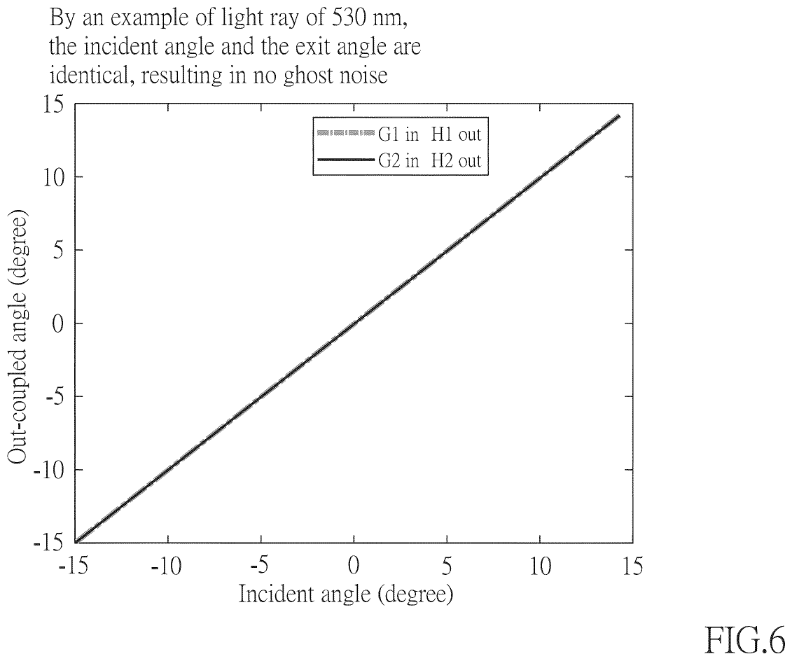

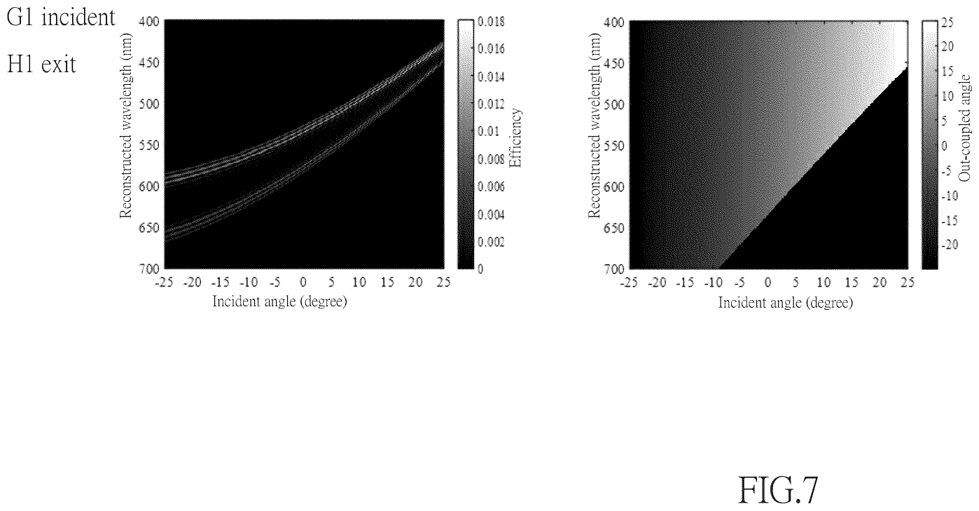

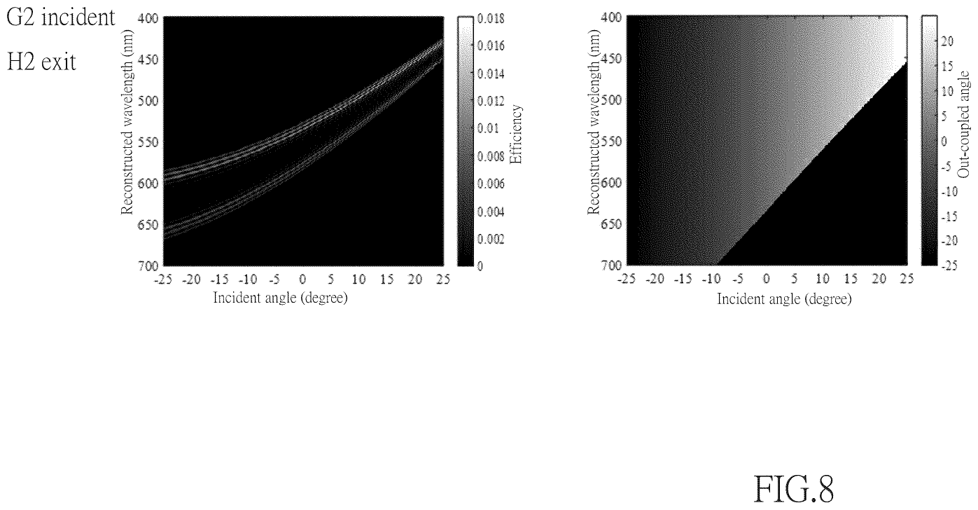

In the volume holographic optical element designed according to the present invention, as shown in FIGS. 3 and 4, even though the volume gratings correspond to different incident angle lights, by the horizontal components of the vectors for the volume gratings with respect to the incident interface being designed to be the same (K_{g,x}=K′_{g,x}), as well as the horizontal grating periods of the volume gratings with respect to the incident interface being the same (Λₓ=Λ′ₓ), as shown in FIGS. 5 to 8, whether the light processed by the volume grating G1 or the volume grating G2 enters the volume grating H1 or the volume grating H2, it would result in identical incident and exit angles due to the same diffraction angle. Therefore, the final imaging will appear at the target position, thereby avoiding the occurrence of ghost noise.

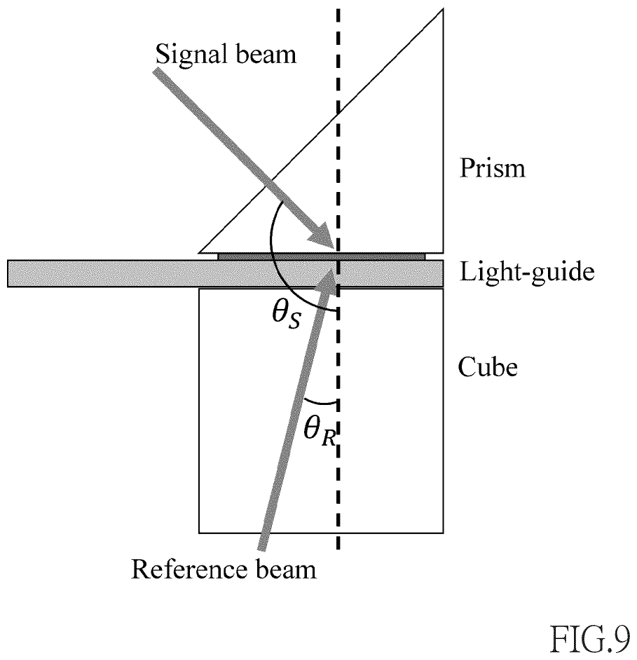

The results are presented in the table below, with reference to FIG. 9.

| | θ_{S} | θ_{R} | K_{g, x} |
|---|---|---|---|
| Volume Grating1 | 131.38° | −6° | 1.47e+07 |
| Volume Grating2 | 117.39° | 6° | 1.47e+07 |
| Volume Grating3 | 104.73° | 6° | 1.47e+07 |

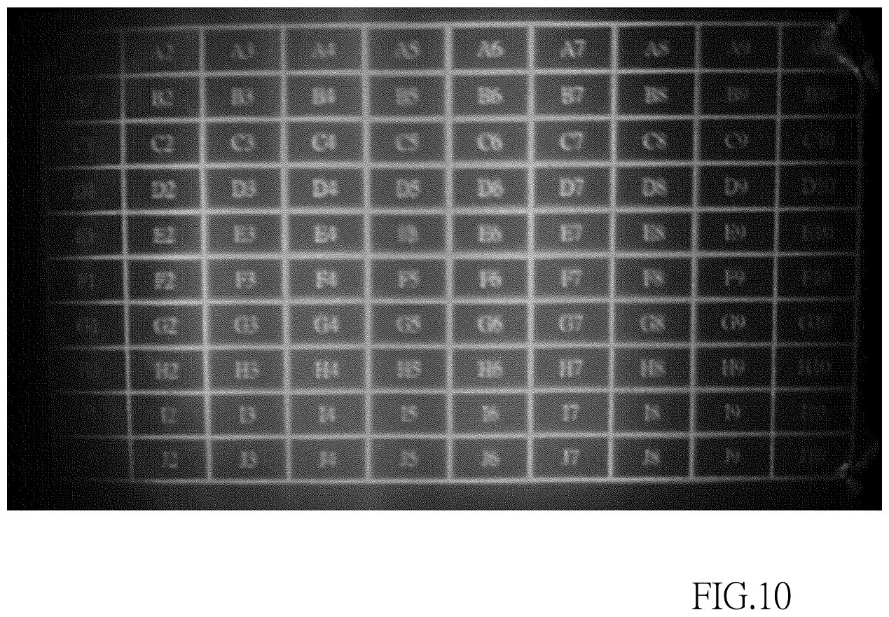

This is the actual sample data implemented by the inventor. In this embodiment, the incident angle of the signal light is adjusted by modulating the internal prisms of the volume gratings to make θₛ meet the requirements, thus making completely identical K_{g,x} for the volume gratings. The final imaging is shown in FIG. 10, which is a monochrome image for DFOV=30 degrees and entirely devoid of ghost noise.

What is claimed is:

1. A volume holographic optical element to avoid ghost noise, wherein:
the volume holographic optical element includes a plurality of volume gratings, which correspond to different incident angle lights, respectively, and have vectors designed with the same component horizontal to an incident interface and possess identical grating periods horizontal to the incident interface.
